(19) United States
(12) Patent Application Publication
(10) Pub. No.: US 2018/0260923 A1
(43) Pub. Date: Sep. 13, 2018

(54) COPYRIGHT DATABASE AND COPYRIGHT TRADING METHOD ON INTERNET

(71) Applicant: Jun Sung LEE, Gimcheon-si Gyeongsangbuk-do (KR)

(72) Inventor: Jun Sung LEE, Gimcheon-si Gyeongsangbuk-do (KR)

(21) Appl. No.: 15/758,346

(22) PCT Filed: Sep. 9, 2015
(86) PCT No.: PCT/KR2015/009506

§ 371 Date: Mar. 8, 2018

(51) Int. Cl. G06Q 50/18; G06Q 40/04

(52) U.S. Cl. CPC G06Q 50/184; G06Q 30/0645; G06Q 40/04

(57) ABSTRACT

The present invention relates to a copyright database and copyright trading. Provided are a system and a method for trading a copyright, the system receiving copyright information from a copyright database, displaying a work of a copyright holder to a copyright “user”, providing information between the copyright holder and the user, and performing trading therebetween.

### TECHNICAL FIELD

The present disclosure relates to copyright database and copyright trading, and more particularly, to an easy search method of copyright, an intermediary role as a mediation site between copyright holders and copyright “users” whenever copyright is traded or rented, and a proactive avoiding method against any potential copyright dispute.

### BACKGROUND TECHNOLOGY

Currently, copyright is often neglected on use. Sometimes it is hard to contact a specific copyright holder when a copyright user knows who holds it. Even if the copyright use is allowed by a copyright holder by an acquaintance, it cannot be proven later without any written consent. On Internet, copyright disputes are very common against songs and videos of YouTube with no allowed copyright, or rashly shared photos in Instagram or many blogs.

### DETAILED EXPLANATION

### Technical Challenges

The present disclosure provides a method of systemization and database construction from a lot of pictures, songs, documents, videos or books floating on Internet that makes people recognize and find related copyright holders easily. Furthermore, the present disclosure is directed to provide a mediation site between copyright holders and consumers to resolve copyright disputes easily and prevent a possible copyright dispute. In addition, various aspects of the present disclosure are directed to provide a protecting method for a copyright holder's work that are abused currently to reduce economic loss, create job opportunities, and materialize vague copyright laws.

### Method to Resolve Challenges

The method of the present disclosure can protect and categorize copyrights and trade them on Internet. An information provider (copyright holder) receives and manages account number, summary and detailed information of his/her copyright. For example, when the present disclosure receives a URL address or an original file, the copyright holder can display the comment like following: [Must negotiate when share this video, use it for commercial use, or change a primary work of the copyright holder into a secondary work], [Fixed term use], or [When this work is used for commercial use, X % of gain will belong to the copyright holder.]. Basically, users can only see open information that was chosen by copyright holders. It will protect the personal information of the copyright holders, issue the trade certificate as an intermediary between copyright holders and copyright users and prove the transaction to avoid copyright disputes. In addition, the copyright market will be more active because the trades of copyrights will be performed easily.

### EFFECT

According to the exemplary embodiment of the present disclosure, it is possible to provide easy browsing for copyright holders' works through computerized communication by systemizing and constructing database for the works. The copyright trade system confirms the trade between a copyright holder and a copyright user in real time basis.

The trade certificate issued by the present disclosure can be used effectively when a copyright dispute happens.

When a copyright holder and a copyright user trade the copyright, the copyright holder is capable of indicating that the copyright user can apply the copyright for commercial use, sell it, rent it during fixed terms, or use as a secondary work to trade it easily and quickly. If a copyright holder is available to sell a copyright work immediately after he/she commercializes it, a lot more people will be interested in creation, The growth in copyright trade will generate many creative jobs to lead economic growth.

Finally, when a corporate or a private business owner looks for a necessary creative work or human resource for a certain field, the copyright database is capable of showing a candidate who has the proper ability and talent. It will make a creator scouting easier to give a creator a job.

### BRIEF DESCRIPTION OF THE DRAWING

FIG. 1 is an overall system configuration diagram according to an exemplary embodiment of the present disclosure

FIG. 2 is a detailed configuration view of FIG. 1.

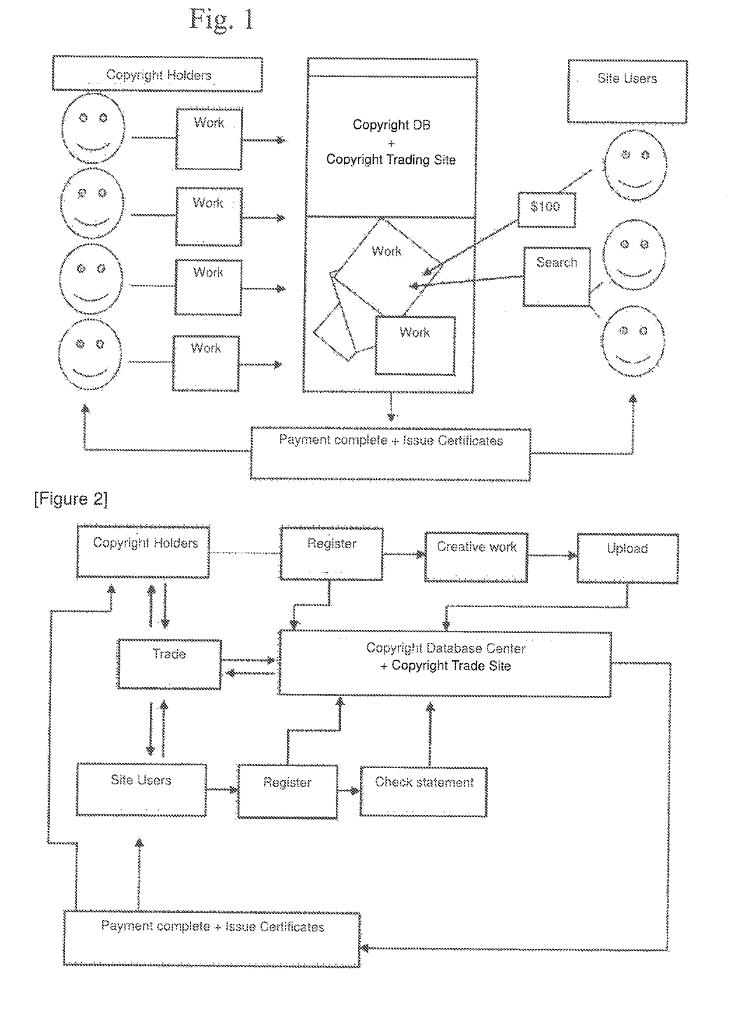

### BEST FORM OF EMBODIMENT

To confirm the copyright holder identity, the present disclosure receives a work from a copyright holder like following:

When uploading a music work, the copyright holder's own voice is acceptable and especially recommends a music video form. If its lyric or melody came from another primary work to make secondary work, the primary work reference has to be clearly revealed. (It is not applicable his/her work is a primary work.)

To prove that a copyright holder draw a specific work, the copyright holder has to upload the original PSD or XCF files that are used to make png or jpeg file. If necessary, working video file is capable to be attached.

The working video that has to be uploaded shall show the copyright holder and shall not be edited in circumstances. The video can have a proof of working especially with any cooperators or assistants if they exist.

In case of a book, a copyright holder has to upload an above mentioned proof that can prove his/her work in circumstances including a design of the plot.

The next step of the present disclosure is a systemizing process for the files that are uploaded by copyright holders. It categorizes them into books, songs, videos, drawings or comics. It allows that a copyright holder is capable of attaching information and notice on his/her work, and keeps them in database to be browsed. Also, a copyright holder holds ability to update his/her information and notice for his/her own work.

### INDUSTRIAL AVAILABILITY

The present disclosure receives copyright information from copyright holding companies and individuals to create a database and provides an easy browsing method to find out whom the copyright holder is, in order to prevent social cost loss. Also, it is possible that the present disclosure makes the trading between a copyright holder and a copyright user easy and issues a trade certificate to protect companies and individuals mutually against social cost loss from any copyright dispute. That's why it has a great industrial value.

What is claimed is:

1. Copyright database construction method and copyright trade/rent method including:
A step in which copyright holders and copyright users sign up and log in on Internet;
A step in which copyright holders store creation proofs and work summary in database;
A step in which the present disclosure provides (displays) transaction information to both parties in real time basis when information of a copyright holder is provided (displayed) to a copyright user, copyright work is traded, or a copyright user buys off the shelf if the price is already revealed;
A step in which the present disclosure is rewarded at the time of completion of a trade between a copyright holder and a copyright user;
A step in which the present disclosure stores a trade certificate and proofs from a copyright holder and a copyright user in a database;
And a step in which the present disclosure sends the trade certificate to a copyright holder and a copyright user.
